(19) United States
(12) Patent Application Publication
(10) Pub. No.: US 2003/0148085 A1
(43) Pub. Date: Aug. 7, 2003

(54) Fiber-reinforced thermoset composite rods bonded to wood

(76) Inventor: Christopher M. Edwards, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/325,239

(22) Filed: Dec. 20, 2002

Related U.S. Application Data
(60) Provisional application No. 60/344,230, filed on Dec. 28, 2001.

(51) Int. Cl. B32B 21/02

(52) U.S. Cl. 428/292.4

(57) ABSTRACT

Wood can be reinforced with a continuous fiber-reinforced thermoplastic or thermoset rod disposed in slots or bores in the wood. The cross-section of the rod is critical to performance, with non-circular cross-sections being preferred over circular cross-sections.

### CROSS-REFERENCE STATEMENT

This application claims the benefit of U.S. Provisional Application No. 60/344,230, filed Dec. 28, 2001.

### BACKGROUND OF THE INVENTION

The present invention relates to wood that is reinforced with a fiber-reinforced thermoset composite rods.

As a result of dwindling stocks of high quality lumber, wood product engineers have had to adopt innovative designs to enhance the structural properties and reduce the cost of wood products. Examples of these designs include glue laminated wood beams, laminated veneer lumber, parallel strand lumber laminated wood columns, wood I-beams, and wood trusses. However, merely redesigning the lumber products has not proved adequate. Therefore, efforts have continued to combine low quality, low cost lumber with structurally reinforcing composites to achieve the same performance as achieved with higher cost, higher quality wood products.

For example, O'Brien in U.S. Pat. No. 5,026,593 discloses the use of a thin flat aluminum strip to reinforce a laminated beam. O'Brien teaches that the aluminum strip must be continuous across the width and length of the beam and that the reinforcing strip may be affixed to the lowermost lamina to improve tensile strength or to the uppermost lamina to improve compression strength of the beam.

In U.S. Pat. No. 5,362,545, Tingley (hereinafter “Tingley '545”) discloses the use of reinforced plastics in glue laminated wood beams (glulams). More particularly, Tingley '545 discloses the use of pultruded composites as materials. These composites are prepared by impregnating thermoset or thermoplastic resins into a continuous fiber bundle. The disclosed thermoset resins include epoxy resins, polyesters, vinyl esters, phenolic resins, polyamides, and polystyrylpyridine while the thermoplastic resins include polyethylene terephthalate and nylon-66. The preferred fibers are disclosed as being aramid or carbon fibers or high modulus polyethylene fibers. Tingley '545 discloses that it is necessary to “hair up” the surface of the fiber-reinforced composite so that fibers protrude, thereby providing a means of adhering the wood to the composite without having to use expensive epoxy adhesives.

In U.S. Pat. No. 5,498,460, Tingley discloses improved adhesion of the fiber-reinforced composite to the wood by creating multiple recesses distributed over the opposed major surfaces of the composite.

In U.S. Pat. No. 5,547,729, Tingley discloses abraded or haired up synthetic tension and compression reinforcements to provide enhanced tensile and compression strength.

In U.S. Pat. No. 5,641,553, Tingley discloses a reinforcing panel comprising a plurality of substantially continuous and parallel synthetic fibers, affixed to at least one cellulose surface material, which improves adhesion of the panel to a wood structure.

In U.S. Pat. No. 5,885,685, Tingley discloses an aramid fiber mat encased in resin along with the fiber-reinforced composite to reduce interlaminar shear failure when nonepoxy resins are used for encasement.

In U.S. Pat. No. 6,037,049, Tingley discloses a composite that comprises two types of fiber strands encased in a resin matrix, a high strength fiber for the central portion of the composite and a lower strength fiber for the edges. The use of lower cost fibers along the edges reduces waste during a planing process.

In view of the high cost of composite materials, it would be an advantage in the art of composites to prepare structural lumber with a optimal amount of fiber-reinforced composite.

### SUMMARY OF THE INVENTION

The present invention addresses a problem in the art by providing a reinforced wood structure comprising an elongated wood member having elongated slot or bore and a continuous fiber-reinforced thermoset rod disposed within the slot or bore, wherein the rod has a non-circular cross-section.

In a second aspect, the present invention is a reinforced wood structure comprising an elongated multilamellar wood member having a longitudinal center, a transverse center, an uppermost lamina, a lowermost lamina, and a plurality of elongated fiber-reinforced thermoset composite rods, wherein at least one of the rods is a tension reinforcement rod and at least one of the rods is a compression reinforcement rod, wherein the tension reinforcement rod is disposed through the longitudinal center, imbedded into and adhering to the lowermost lamina of the multilamellar structure, wherein the compression reinforcement rod is disposed through the longitudinal center and imbedded into and adhering to the uppermost lamina of the multilamellar structure.

### BRIEF DESCRIPTION OF THE DRAWINGS

FIG. 1a-d illustrate glulam structures containing reinforcing composite rods disposed in slots of a slotted lamina.

FIG. 2 illustrates composite rods reinforced with different fibers.

FIG. 3a-c illustrate glulam structures with alternating composite/wood reinforcement.

### DETAILED DESCRIPTION OF THE INVENTION

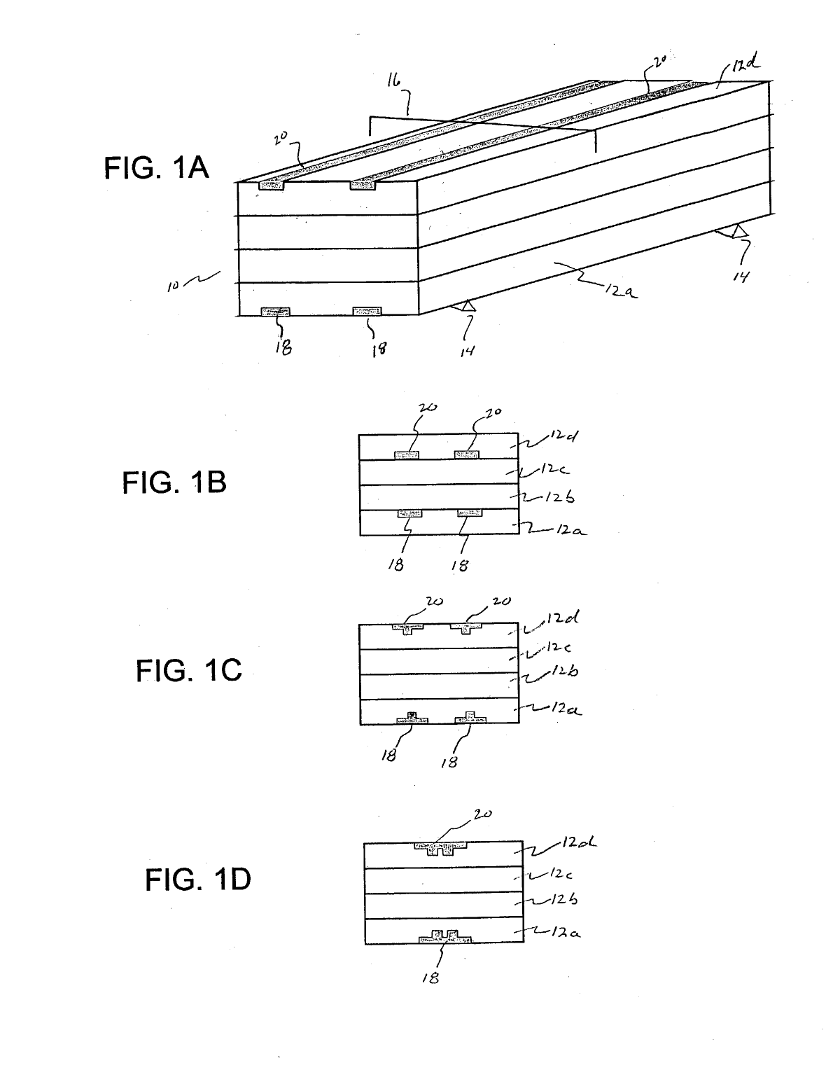

In a preferred embodiment of the present invention, FIG. 1a shows an elongated glue laminated wood structural member 10 having multiple wood laminae 12 that are bonded together as elongated boards. The wood structural member 10 is shown with its ends supported by a pair of blocks 14 and bearing a point load 16 midway between the blocks 14. (The point load is located at the longitudinal center.) It will be appreciated that the glue laminated wood member 10 could also bear loads distributed in other ways (for example, cantilevered) or be used as a truss, joist, or column. It will also be appreciated that the wood member 10 can be in the form of laminated veneer lumber (LVL).

Under the conditions represented in FIG. 1a, the lowermost lamina 12a is subjected to a substantially pure tensile stress and the uppermost lamina 12d is subjected to a substantially pure compressive stress. To increase the tensile load-bearing capacity of the glue laminated wood member 10, the lowermost lamina 12a is slotted and fitted with one or more thermoset synthetic tension rods 18; to increase the compressive load-bearing capacity of the glue laminated wood member, the uppermost lamina 12d is slotted and fitted with one or more thermoset synthetic compression rods 20. The reinforcing rods can be situated at the uppermost and lowermost extremities of the wood member, as shown in FIG. 1a, or arranged so that either or both of the slotted sides of the slotted laminae face the adjoining wood members 12b and 12c, as shown in FIG. 1b.

Referring back to FIG. 1a, the reinforcing rods 18 and 20 are advantageously positioned through the longitudinal center 16 and preferably extend from about 20% to about 100% of the length of the wood member 10.

The ratio of the cross-sectional perimeter of the reinforcing rod to its cross-sectional area is higher than that of a circular rod. Accordingly, the reinforcing rod has a non-circular cross-sectional shape such as oval, polygonal, T-shaped (as illustrated if FIG. 1c), or II-shaped (as illustrated in FIG. 1d); moreover, the rod can be solid or hollow. It is further desirable that the shape of the slot or bore closely resembles the shape of the rod so as to minimize the amount of adhesive required. Since the slot is advantageously prepared using standard milling or routing cutters, the shape is usually selected by the ease with which it can be milled or routed. Thus, rods with rectangular cross-sections are more preferred. Indeed, it has been discovered that non-circular cross-sectional rods give improved performance over circular cross-sectional rods for a given volume of the rod. In other words, these non-circular cross-sectional rods give the same performance using less material than rods with circular cross-sections.

Although rectangularly shaped rods are theoretically preferred, it may be desirable to prepare rectangular rods with rounded edges, which are generally easier to make and handle. It may also be desirable to place protuberances on the sides or corners of the rod to aid in the centering of the rod in the slot or bore, to increase the perimeter to cross-sectional area, and to increase the mechanical bond between the rod and the wood.

The rods are continuous fiber-reinforced thermoset composites. Examples of suitable matrixes including epoxy resins, thermoset polyesters, vinyl esters, phenolic resins, polyamides, and polystyryl pyridines. Examples of suitable reinforcing fibers include glass, carbon, aramid fibers, ceramic, and various metals or combinations thereof. Indeed, as illustrated in FIG. 2, it may be desirable to prepared a rod having two types of fibers, a less stiff, less expensive fiber bundle (for example, glass) 26 disposed toward to the transverse center 25 of the glue laminated wood member 10, and a stiffer more expensive fiber bundle 28 disposed further from the transverse center 25.

The rod may be adhered to the wood by an uncured adhesive such as an epoxy resin, which can be cure in situ. The rod may also be overextruded or overmolded with a compatible polymer with greater affinity for adhesion to wood than the composite matrix. Examples of compatible polymers include polar polymers such as ABS, nylon, polycarbonate, TPU, PET.

It is also possible to prepare the reinforced structure in the absence or substantial absence of adhesive or compatibilizing polymer. For example, an uncured thermoset composite rod may be made in situ in the slot or bore by hand layup of fibers and resin into the slot or bore; alternatively, fibers can be pulled through a resin bath and the wetted bundle of fibers can be layed into the slot or inserted into the bore and allowed to cure in place.

The composite rod is advantageously prepared by a pultrusion method such as those well known in the art. See, for example, Tingley in U.S. Pat. No. 5,362,545, FIGS. 1 and 2 and descriptions thereof. The composite rod may contain surface modification including abraded, haired up, or recess modification using modification methods known in the art.

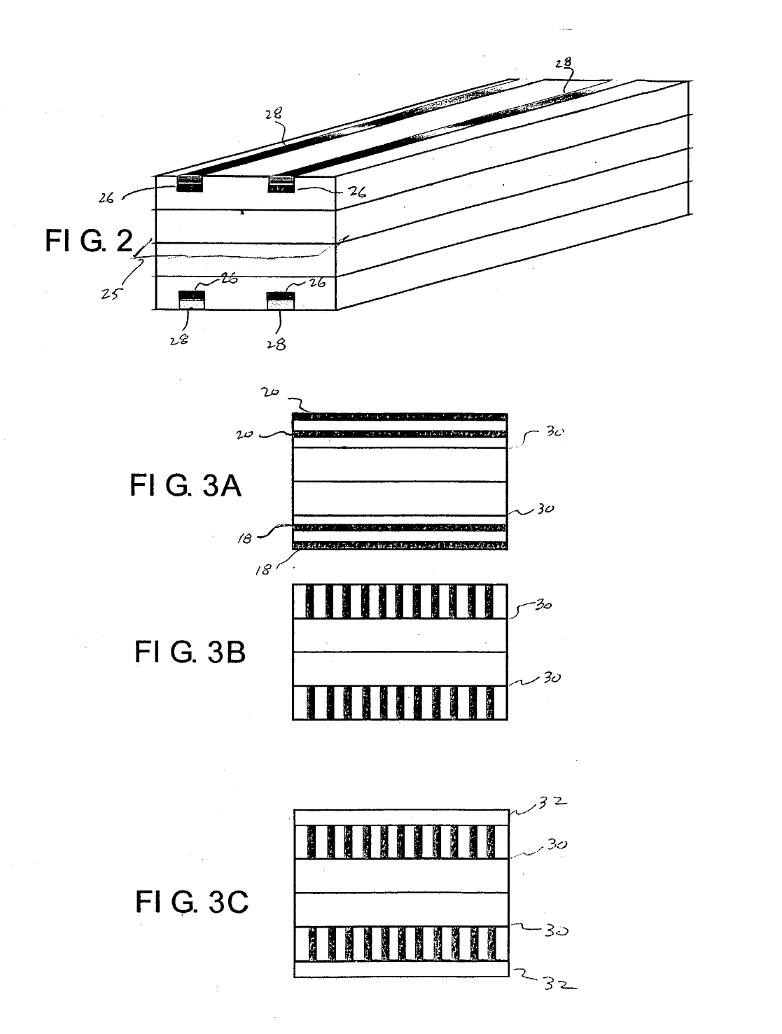

In another embodiment of the present invention, illustrated in FIG. 3a-c, the uppermost and lowermost lamina may be designed with layers of alternating composite and wood sheet. The layers may be parallel to the glulam interface 30 as shown in FIG. 3a, or perpendicular to the interface 30 as shown in FIG. 3b. The reinforcement can also be hidden by a suitable cap 32 (for example, wood, thermoplastic, or thermoset) as shown inf FIG. 3c.

What is claimed is:

1. A reinforced wood structure comprising an elongated wood member having an elongated slot or bore and a continuous fiber-reinforced thermoset rod disposed within the slot or bore, wherein the thermoset rod has a non-circular cross-section.

2. The reinforced wood structure of claim 1 wherein the thermoset rod has a polygonal, star-shaped, or elliptical cross-section.

3. The reinforced wood structure of claim 2 wherein the polygonal cross-section is rectangular or triangular.

4. The reinforced wood structure of claim 1 wherein the fiber-reinforced rod contains an epoxy resin, a polyester, a vinyl ester, a phenolic resin, a polyamide, or a polystyryl pyridine.

5. A glulam or laminated veneer wood structure comprising an elongated multilamellar wood member having a longitudinal center, a transverse center, an uppermost lamina, a lowermost lamina, and a plurality of elongated fiber-reinforced thermoset composite rods having a non-circular cross-section, wherein at least one of the rods is a tension reinforcement rod and at least one of the rods is a compression reinforcement rod, wherein the tension reinforcement rod is disposed through the longitudinal center, imbedded into and adhering to the lowermost lamina of the multilamellar structure, wherein the compression reinforcement rod is disposed through the longitudinal center and imbedded into and adhering to the uppermost lamina of the multilamellar structure.
